(19) United States
(12) Patent Application Publication
(10) Pub. No.: US 2005/0274803 A1
(43) Pub. Date: Dec. 15, 2005

(54) Portable dual-mode contact and contactless communication device

(76) Inventor: Kam Wing Eric Lee, Tsuen Wan (HK)

Correspondence Address: KNOBBE MARTENS OLSON & BEAR LLP, 2040 MAIN STREET, FOURTEENTH FLOOR, IRVINE, CA, 92614, US

(21) Appl. No.: 11/148,776

(22) Filed: Jun. 8, 2005

(30) Foreign Application Priority Data
Jun. 9, 2004 (HK) 04104126.5

(51) Int. Cl. G06K 7/00; G06K 7/06; G06K 7/08

(52) U.S. Cl. 235/439; 235/441; 235/451

(57) ABSTRACT

A communication device comprising a portable casing having space adapted to receive at least one digital and communication integrated circuit (IC) or smart card therein; the casing also containing a contact smart card connector that is adapted to electrically couple to the smart card. A contact smart card reader electronic module is provided within the casing and connecting the smart card connector to an external port, the external port adapted for electrically coupling to an external host for data exchange between the smart card and the external host. This device also contains an antenna assembly adapted to electrically couple to the IC or smart card for wireless data transmission between this device and an external contactless smart card reader.

### CROSS-REFERENCE TO RELATED APPLICATIONS

This patent application claims priority under 35 U.S.C. § 119 to Hong Kong Application No. 04104126.5 filed Jun. 9, 2004, now Hong Kong Short Term Patent No. 1063994A.

### FIELD OF INVENTION

This invention relates to an electronic communication devices, and in particular smart-card related devices with dual-mode contact/contactless functions.

### BACKGROUND OF INVENTION

A smart card consists of an IC chip typically embedded in a flat enclosure. It comes with two popular form factors. One of them is the size of a credit card which is widely used in banking and national ID card projects. The other form factor is the smaller subscriber identification module (SIM card) used in mobile phone. The IC chip itself can simply be a memory chip or a microprocessor chip. Typically, a smart card has eight electric pins which are generally referred to as C1 to C8 to communicate to the external world. Their roles and functions are defined in ISO7816 international standard. A smart card reader is a device that will make electrical contact with each of these pins, so that an external host device can communicate with the smart card through the reader. Out of these 8 pins, ISO7816 standard defines 6 of them for the use of carrying electric power, the clock and reset signals as well as data input and data output signals between the reader and the card. Pins C4 and C8 are not defined and some manufacturers are using these 2 pins to carry out special functions, which will be described later. This type of smart card is said to operate in a contact mode, as it needs to make physical contact with the card reader in order for it to get the electrical power and to communicate with the external world.

There is another kind of smart card that can operate in a contactless mode. It is based on the Radio Frequency Identification (RFID) technology. In this case, the contactless smart card reader, also known as the interrogator, sends out the Radio Frequency (RF) signal. The contactless smart card contains a contactless chip which is electrically coupled to an antenna and its RF circuitry is tuned to receive the RF signal at this frequency. When the contactless card is in the vicinity of the interrogator, it picks up the RF signal, and uses it to power the RF and digital circuitry within the contactless IC. The interrogator and the contactless smart card also communicate with each other through the same RF channel.

Smart cards operating in contact mode have been widely used in many applications where security and privacy are the prime concerns. These include banking transaction, credit card processing, on-line electronic commerce, logical access to computer systems, as well as national identification card projects, health care and social security card projects. Another mass adoption of smart card technology is the subscriber identification card (SIM card) used in the GSM mobile phone handsets. On the other hands, contactless smart card technology is more convenient to use, as users do not need to physically insert the smart card into the card reader. Hence, it is widely used in physical access control, micro-payment of mass transit systems and many other applications. However, the latter technology may not offer the same level of security protection as the contact mode of operation, because the wireless data transmission could be eavesdropped by a rogue contactless reader located in close proximity of the genuine one.

As a result, vendors have developed a dual-mode smart card that contains a digital logic and communication integrated circuit (IC) that can operate in both contact mode and contactless mode. An example of such a card is the combi-card, which normally has a form factor that is the same size as a normal credit card. But the SIM card format is also available. It has 8 pin connections as per normal contact smart card which can couple to a smart card reader in contact mode of operation. For the normal credit card size combi-card, it also has an embedded antenna inside the card so that it can function as a contactless card by itself. For the SIM card format combi-card, an external antenna is needed and pins C4 and C8 are used by some vendors to connect to the external antenna.

### SUMMARY OF INVENTION

In the light of the foregoing background, embodiments of the present invention provide an alternate electronic device that can function as a contact smart card reader in one way, and also a contactless card in another way.

Accordingly, certain embodiments are exemplified by a communication device comprising a portable casing having space adapted to receive at least one digital and communication integrated circuit (IC) or smart card therein; the casing also containing a contact smart card connector that is adapted to electrically couple to the smart card. A contact smart card reader electronic module is provided within the casing and connecting the smart card connector to an external port, the external port adapted for electrically coupling to an external host for data exchange between the smart card and the external host. This device also contains an antenna assembly adapted to electrically couple to the IC or smart card for wireless data transmission between this device and an external contactless smart card reader.

In one embodiment, the communication device is adapted to accept a dual-mode smart card (such as in a SIM format) card therein with the contact smart card connector contained within the casing adapted to electrically couple to the dual-mode smart card. A contact smart card reader electronic module couples the contact smart card connector to an external port, which in turn is adapted for electrically coupling to an external host for data exchange between the dual-mode smart card and the external host. The antenna assembly is adapted to electrically couple to the contact smart card connector pins C4 and C8 for wireless data transmission between the contactless module of the dual-mode smart card and an external contactless smart card reader.

In another embodiment, at least one contact smart card and a separate contactless IC chip are provided within the portable communication device. The contact smart card connector contained within the casing is adapted to electrically couple to the smart card; the contact smart card reader electronic module can couple the smart card connector to an external port, with the external port adapted for electrically coupling to an external host for data exchange between the contact smart card and the external host. The antenna assembly provided within the casing is adapted to electrically couple to the contactless chip for wireless data transmission between this portable device and an external contactless smart card reader.

In one implementation of the aforesaid embodiments, either or both the smart card connector and the antenna assembly are fabricated on a printed circuit board.

In another implementation, the printed circuit board is a multi-layer printed circuit board with at least two layers of the printed circuit board containing at least a portion of the antenna assembly. In a preferred embodiment, the antenna of the antenna assembly is embedded as part of the casing.

According to another embodiment using a dual-mode contact and contactless communication device similar to the ones described above, a method of forming the antenna assembly is provided. The first act of this method is laying metal conductors in a printed circuit board to couple electronic components of an export port, a contact smart card reader electronic module, and a contact smart card connector theretogether. At least one metal wire is then embedded in a position proximate the perimeter of the printed circuit board to electrically couple the metal wire to a contactless IC (e.g., a combi-card or a contactless chip) such that the metal wire functions as an antenna for the antenna assembly for wireless transmission.

In a variation of the above method, a further act of embedding at least one second metal wire to at least a second layer of the printed circuit board is provided. In addition, there is an act of connecting the first metal wire with the second wire electrically.

In a further embodiment, a method of dual-mode contact and contactless electronic communication is provided comprising the acts of connecting a portable dual-mode contact and contactless communication device to an external host via a smart card reader electronic module provided within the communication device and transferring data to and from the communication device in a contact mode of operation; and communicating the communication device with a contactless smart card reader in a contactless mode of operation.

In a preferred embodiment, the export port is a serial and USB (Universal Serial Bus) port. Smart cards having the SIM form factor are also preferred.

There are many advantages to embodiments of the present invention as it enables many new applications. For example, users can store secret keys and password information inside the dual-mode SIM sized smart card. When the user wants to log on to a computer system, he can couple the device to a USB port. A software program can be automatically initiated to authenticate the user and allow him access to the computer. When the user wants to access certain restricted premises, it can function in contactless mode as a physical access device for the user. In another application scenario, the dual-mode smart card can be configured as a store-value card. The user can use the contact-mode of operation to top up the stored value, and use the contactless-mode of operation to pay service fee. The contact-mode ensures high security while the contactless-mode offers user convenience. In fact, the device can be made small enough as a personal electronic key that is always carried by the user in his key-chain. The fact that the antenna may be fabricated as part of the casing allows the smallest possible footprint for the device.

Another advantage is that in the embodiment where the contactless IC is separated from the contact SIM card, the contact SIM card may be exchanged or replaced independently of the contactless IC. This reduces both cost and efficiency of usage.

### BRIEF DESCRIPTION OF FIGURES

FIG. 1 is a block diagram of a dual-mode smart card reader module and antenna assembly according to one embodiment of the invention.

FIG. 2 is a dual-mode smart card whose dimensions conform to the SIM form factor.

FIG. 3 is top view of the dual-mode smart card reader device according to the same embodiment with the top cover removed.

FIG. 4 is the top view of the dual-mode smart card reader device according to the same embodiment with the dual-mode smart card inserted into the smart card connector slot of the device.

FIG. 5A, 5B, 5C and 5D are the first, second, third and fourth layers of the printed circuit board layouts of the device according the same embodiment of the invention.

FIG. 6 is a cover of the device with an antenna embedded inside the cover.

FIG. 7 shows the printed circuit board installed on the cover of the device of the same embodiment with an antenna embedded inside the cover.

FIG. 8 is a block diagram of a smart card reader module and antenna assembly for contact smart card and contactless chip according to a second embodiment of the invention.

FIG. 9 shows the top view of a device according to a second embodiment of the present invention with the cover of the device removed to show electronic card reader module, the card reader connector and the contactless IC chip.

FIG. 10 shows one possible antenna assembly of the second embodiment.

### DETAILED DESCRIPTION OF THE PREFERRED EMBODIMENTS

As used herein and in the claims, “couple” or “connect” refers to electrical coupling or connection either directly or indirectly via one or more electrical means unless otherwise stated.

“Digital logic and communication integrated circuit (IC)” generally refers to electronic processors or memory devices, either embedded within an enclosure or in a chip form without enclosure. For ICs that are embedded in a flat enclosure in the form of a card, they are also known as “smart cards”. Some smart cards contain IC for both contact and contactless modes of operation. Some smart cards contain IC for either the contact or the contactless mode of operation only. There are also ICs that contain circuitry for contactless mode of operation only but not embedded in a smart card.

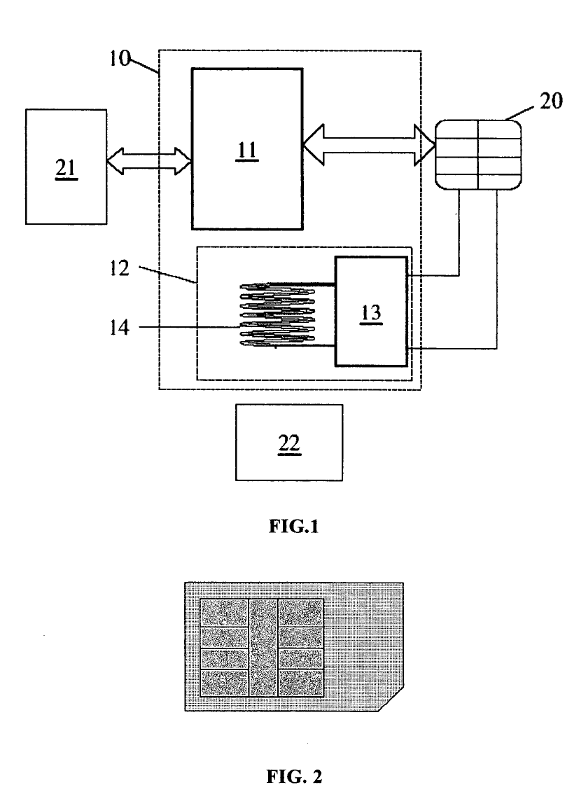

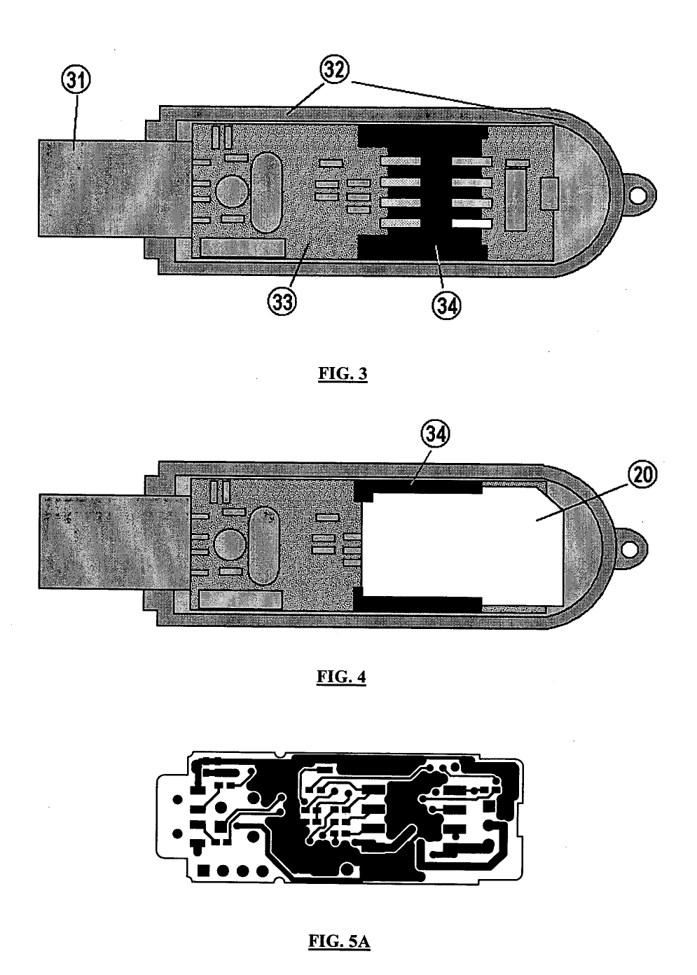

Referring now to FIG. 1, a first embodiment of the present invention is related to a dual-mode smart card reader module 10, which has two major components: a smart card reader electronic module 11 and an antenna assembly 12. The former establishes a communication path between an external host 21 and a smart card 20 so that the external host 21 can read and write information to the smart card 20 under the contact mode of operation. Likewise, the antenna assembly 12 provides the necessary antenna circuitry to smart card 20 so that the latter can communicate with a contactless smart card reader 22 in contactless mode of operation. In this first embodiment, the smart card 20 has a form factor like the SIM card as shown in FIG. 2, and the external host 21 is a computer. The smart card reader electronic module 11 provides a Universal Serial Bus (USB) port 31 (shown in FIG. 3) for connection to the external host 21. However, it should be obvious to one skilled in the art that other interfacing protocols such as a RS232, a RS442 and a RS485 serial interface, as well as a parallel port interface can also be used. The antenna assembly 12 further comprises an antenna 14 and an antenna tuning circuitry 13. For certain dual-mode smart card, there is no need for antenna tuning and in this situation the antenna assembly 12 contains only the antenna 14.

FIG. 3 illustrates the entire device of this embodiment with one part of the casing removed. The entire circuitry of the dual-mode contact smart card reader module 10 is implemented in a printed circuit board 33. In this preferred embodiment, the smart card reader module 10 makes use of the USB port 31 to couple to the external host 21. This module is housed in casing 32. The printed circuit board 33 contains a smart card connector 34 that has 8 pin connectors for making electrical contact with the dual-mode smart card 20. FIG. 4 shows the setting when the smart card 20 is inserted to the smart card connector 34.

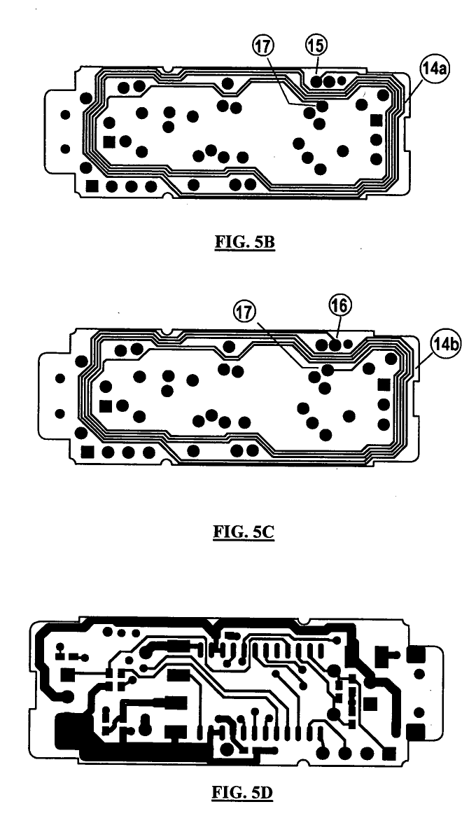

FIG. 5 shows an entire layout of printed circuit board 33. In this preferred embodiment, the printed circuit board 33 has four layers. FIG. 5a and FIG. 5d are the top and bottom layers respectively for the mounting of discrete electronic components. The antenna 14 in FIG. 1 is realized in layer 2 and 3 of the printed circuit board 33. As shown in FIGS. 5b and 5c, each of these two layers comprises five turns of thin electric wires that constitute a portion of the antenna. These wirings run around the perimeters of the printed circuit board so that the antenna 14 thus formed can capture the maximum amount of magnetic flux radiated from the contactless card reader 22. Thin wire 14a makes contact with layer 1 through electrically conducting pin-hole 15, and also with layer 3 through pin-hole 17. Likewise, thin wire 14b makes contact with layer 2 through pin-hole 17 and with layer 1 through pin-hole 16. As such, wiring 14a and 14b are connected together to form a single antenna 14. Antenna 14 couples to the antenna assembly 12 in printed circuit board 33, which in turn couples to pins C4 and C8 of the smart card connector 34.

Since the electric power that can be coupled to the smart card 20 from the contactless smart card reader 22 depends on the number of turns that the loop antenna 14 has, and also the area it encloses, the wiring 14a and 14b preferably occupy the perimeter of the printed circuit board 33. To increase the number of turns, the loop antenna 14 occupies two layers of the printed circuit board in this specific embodiment. Moreover, as surface mount technology is adopted to put electronic components to the printed circuit board 33, the top and bottom layers are dedicated for interconnecting electronic components together to realize the circuitry of the dual-mode smart card reader module 10. Hence in this embodiment, the loop antenna 14 occupies the inner two layers. If there is no size constrain, the antenna can be co-located with the rest of the electronic circuitry and hence the number of layers in the printed circuit board 33 can be reduced. Although this preferred embodiment has been described specifically, it is clear that many variations and combinations are possible in the light of the teaching provided herein. Specifically, the number of turns of the antenna wiring, its placement on the circuit board, and the number of layers of the printed circuit board used are variations that those skilled in the technical art can adapt to their specific applications.

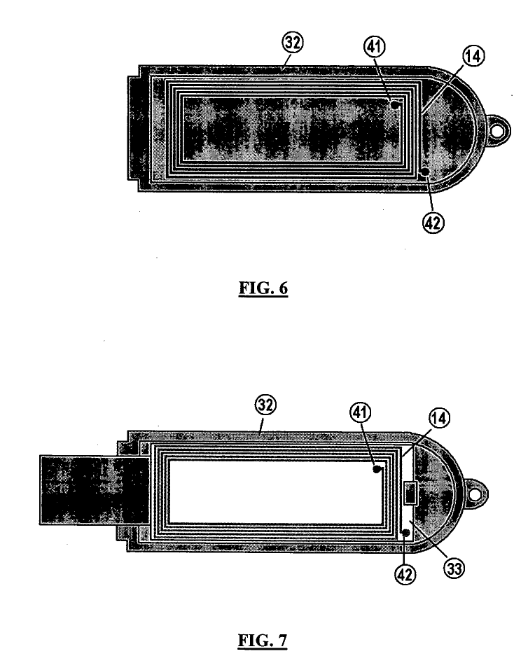

In another implementation of this embodiment, the antenna 14 is embedded in the casing 32 as shown in FIG. 6. The antenna can be constructed using thin metal wires wound in loops or other forms, or it can be printed onto the cover using conductive inks. The main purpose is that the antenna thus formed can receive the electromagnetic wave radiated from the contactless card reader. At the printed circuit board 33 shown in FIG. 7, spring connectors can be placed directly underneath antenna leads 41 and 42, so that when the cover 32 encloses the printed circuit board 33, these spring connectors make electrical connections to antenna leads 41 and 42. In implementation of this embodiment, a flexible circuit board can be used to form the antenna 14, and the former can be glued to the back of the cover 32 by adhesive means. The antenna 14 can be coupled to the printed circuit board 33 through ordinary electrical wires and connectors. It should be obvious to one skilled in the art that there can be a plurality of methods to embed the antenna 14 to the cover 32 and couple the antenna to the printed circuit board 33; and the antenna can be made using a variety of electrically conducting materials.

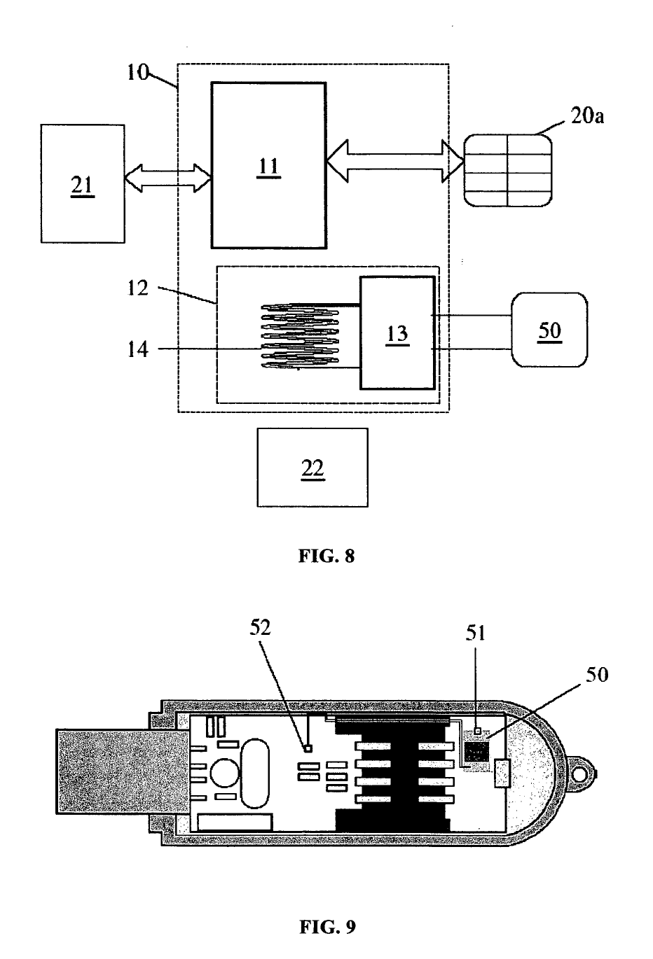

FIG. 8 shows another embodiment of the present invention in which the contact and contactless functions are implemented on two different IC chips. For simplicity of description, the features that are the same as the first embodiment are given the same numbers as they serve the same function, and their descriptions are not repeated here. In this embodiment, a SIM card 20a having a contact mode of operation replaces SIM card 20 of the first embodiment in the same casing. It interacts with smart card connector 34 in the contact mode in the same way as previously described. Additionally, a contactless IC 50 is provided in this second embodiment and a pair of electrical connections 51 and 52 is added to connect IC 50 to the antenna assembly 12, which allows contactless IC chip 50 to interact with an external contactless smart card reader.

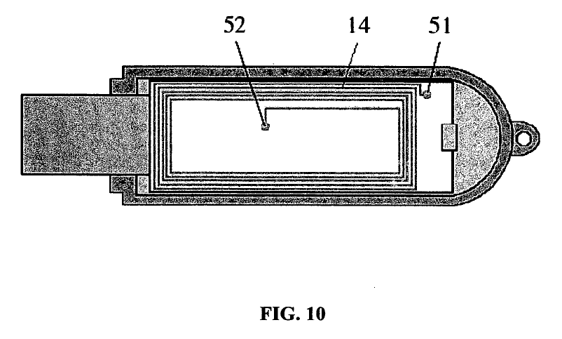

FIGS. 9 and 10 show how the pair of electrical connections 51 and 52 links the contactless IC 50 to antenna 14 (not shown in FIG. 9). As in the previous embodiment, the antenna tuning circuitry is an optional feature of the antenna assembly.

The preferred embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, it should be noted that the metal conductors that realize the circuit diagram of the smart card reader electronic module should not form closed loops. Moreover, for a multi-layer printed circuit board, the metal wire for the antenna may occupy more than one layer. In such case, electrically conducting pin-holes will be used to couple wires from multiple layers together so that it constitutes a single antenna.

1. A communication device comprising:
a. a portable casing having space adapted to receive at least one digital logic and communication integrated circuit (IC) therein;
b. a contact smart card connector contained within the casing, the contact smart card connector adapted to electrically couple to the IC;
c. a contact smart card reader electronic module within the casing and coupling the contact smart card connector to an external port, the external port adapted for electrically coupling to an external host for data exchange between the smart card and the external host; and
d. an antenna assembly adapted to electrically couple to the IC for wireless data transmission between the IC and an external contactless smart card reader.

2. The device according to claim 1, wherein the contact smart card connector is fabricated on a printed circuit board.

3. The device according to claim 2, wherein the antenna assembly is fabricated in the printed circuit board.

4. The device according to claim 3, wherein the printed circuit board is a multi-layer printed circuit board with at least two layers of the printed circuit board containing at least a portion of the antenna assembly.

5. The device as in claim 1, wherein the antenna of the antenna assembly is embedded as part of the casing.

6. A communication device comprising:
a. a portable casing having space adapted to receive a dual-mode smart card therein;
b. a contact smart card connector contained within the casing, the smart card connector adapted to electrically couple to the dual-mode smart card;
c. a contact smart card reader electronic module coupling the contact smart card connector to an external port, the external port adapted for electrically coupling to an external host for data exchange between the dual-mode smart card and the external host; and
d. an antenna assembly adapted to electrically connect to the contact smart card connector for wireless data transmission between the dual-mode smart card and an external contactless smart card reader.

7. The device according to claim 6, wherein the contact smart card connector and the antenna assembly are fabricated on a printed circuit board.

8. The device according to claim 7, wherein the printed circuit board is a multi-layer printed circuit board with at least two layers of the printed circuit board containing at least a portion of the antenna assembly.

9. The device as in claim 6, wherein the antenna of the antenna assembly is embedded as part of the casing.

10. A communication device comprising:
a. a portable casing having space adapted to receive at least one contact smart card and one contactless chip therein;
b. a contact smart card connector contained within the casing, the contact smart card connector adapted to electrically couple to the contact smart card;
c. a contact smart card reader electronic module coupling the smart card connector to an external port, the external port adapted for electrically coupling to an external host for data exchange between the contact smart card and the external host; and
d. an antenna assembly provided within the casing and adapted to electrically couple to the contactless chip for wireless data transmission between the contactless chip and an external contactless smart card reader.

11. The device according to claim 10, wherein the contact smart card connector and the antenna assembly are fabricated on a printed circuit board.

12. The device according to claim 11, wherein the printed circuit board is a multi-layer printed circuit board with at least two layers of the printed circuit board containing at least a portion of the antenna assembly.

13. The device as in claim 10, wherein the antenna of the antenna assembly is embedded as part of the casing.

14. In a dual-mode contact and contactless communication device comprising a portable casing containing at least one smart card, the smart card electrically coupling to an antenna assembly for the contactless mode of operation, a method of forming the antenna assembly comprising:
a. laying metal conductors in a printed circuit board to couple electronic components of an export port, a contact smart card reader electronic module, and a contact smart card connector theretogether,
b. embedding at least a first metal wire in a position proximate the perimeter of the printed circuit board; and
c. electrically coupling the first metal wire to a contactless IC such that the first metal wire functions as an antenna for the antenna assembly for wireless transmission.

15. The method according to claim 14 further comprising embedding at least a second metal wire in at least a second layer of the printed circuit board; and coupling the first metal wire with the second wire electrically.

16. The method according to claim 14 wherein the printed circuit board is a multi-layer printed circuit board and the metal wire is embedded in the inner layers of the multiple layer printed circuit board.

17. The method according to claim 14 further comprising winding an electrically conducting wire around the casing in multiple turns; and coupling the wire to the contactless IC.

18. A method of dual-mode contact and contactless electronic communication comprising coupling a portable dual-mode contact and contactless communication device to an external host via a smart card reader electronic module provided within the communication device and transferring data to and from the communication device in a contact mode of operation; and communicating using the communication device with a contactless smart card reader in a contactless mode of operation.
